(19) United States
(12) Patent Application Publication
(10) Pub. No.: US 2026/0328367 A1
(43) Pub. Date: Oct. 22, 2026

(54) FLAT BULB

(71) Applicant: SAVANT TECHNOLOGIES LLC, East Cleveland, OH (US)

(72) Inventors: Jie GAO, Shanghai (CN); Jing CHEN, Shanghai (CN); Hai HUANG, Shanghai (CN); Chunxiao GAO, Shanghai (CN)

(73) Assignee: SAVANT TECHNOLOGIES LLC, East Cleveland, OH (US)

(21) Appl. No.: 19/573,855

(22) Filed: Mar. 20, 2026

(30) Foreign Application Priority Data
Mar. 21, 2025 (CN) 202520512641.9

(51) Int. Cl. F21V 1/02; F21V 23/00

(52) U.S. Cl. CPC F21V 1/02; F21V 23/003

(57) ABSTRACT

Provided is a flat bulb that includes a lampshade having a lampshade body portion and a lampshade connection portion located at the bottom of the lampshade body portion, a light-emitting element, a driving unit electrically connected to the light-emitting element, and a base connected to the lampshade connection portion for electrically connecting the flat bulb to a socket, the light-emitting element being arranged in an inner space of the lampshade and/or the base, and at least a part of the lampshade body portion having a flat shape. Accordingly, the flat bulb of the present utility model is of a unique design for decorative purposes and can be adapted to various different shapes, and the flat bulb can be fitted to various sockets by the user as required.

### CROSS-REFERENCE TO RELATED APPLICATION

This application claims priority to Chinese Patent Application Serial Number 202520512641.9, filed Mar. 21, 2025, which is herein incorporated by reference.

### DESCRIPTION

### Technical Field

The present utility model relates to the field of lamps, and in particular, to a flat bulb.

### BACKGROUND

In the field of lamps, generally, in order to meet functional requirements while also taking into account certain decorativeness, bulbs in the forms of a spherical bulb, a cylindrical bulb, a spiral bulb, a candle-shaped bulb, a tubular bulb and the like are commonly used, and these bulbs are generally designed to primarily provide basic illumination and have a conservative design.

### SUMMARY

In order to overcome the described defect existing in the prior art, the present utility model provides a flat bulb, comprising: a lampshade, the lampshade comprising a lampshade body portion and a lampshade connection portion located at the bottom of the lampshade body portion; a light-emitting element; a driving unit, the driving unit being electrically connected to the light-emitting element; and a base, the base being connected to the lampshade connection portion for electrically connecting the flat bulb to a socket, the light-emitting element being arranged in an inner space of the lampshade and/or the base, and at least a part of the lampshade body portion having a flat shape. Accordingly, the flat bulb of the present utility model is of a unique design for decorative purposes and can be adapted to various different shapes, and the flat bulb can be fitted to various sockets by the user as required.

Further, the at least a part of the lampshade body portion is circular, elliptical or polygonal; and/or the lampshade is transparent or translucent. Accordingly, the flat bulb of the present utility model can be designed in various shapes or appearances.

Further, the light-emitting element is a filament. Accordingly, the cost can be reduced and the shape or appearance of the flat bulb can be sufficiently fitted.

Further, the lampshade comprises a first lampshade portion and a second lampshade portion, and the first lampshade portion and the second lampshade portion are connected together by glue or ultrasonic welding. Accordingly, the lampshade can be manufactured more easily.

Further, a groove is formed in the first lampshade portion and/or the second lampshade portion, and the light-emitting element is arranged in the groove. Accordingly, the light-emitting element can be securely and stably arranged in the lampshade.

Further, the light-emitting element is arranged between the first lampshade portion and the second lampshade portion. Accordingly, more uniform light emission at both sides of the flat bulb can be achieved.

Further, the light-emitting element is arranged around the lampshade body portion. Accordingly, the flat bulb is more aesthetically pleasing during light emission.

Further, the light-emitting element is arranged in the lampshade body portion. Accordingly, the flat bulb is more aesthetically pleasing during light emission.

Further, the lampshade body portion is composed of a part of the first lampshade portion and at least a part of the second lampshade portion, and the lampshade connection portion is composed of the rest of the first lampshade portion or composed of the rest of the first lampshade portion and the rest of the second lampshade portion. Accordingly, the lampshade can be manufactured more easily.

Further, the driving unit is arranged in the base. Further, a tapered or cylindrical space is formed in the base, and the driving unit is arranged in the tapered or cylindrical space. Accordingly, the driving unit can be better hidden, such that the flat bulb is more aesthetically pleasing.

Further, the driving unit is arranged at an interface between the base and the lampshade connection portion. Accordingly, a balance between the appearance of the flat bulb and the convenience of connection between the driving unit and the light-emitting element can be achieved.

Further, the driving unit is arranged in the lampshade connection portion. Further, a tapered or cylindrical space is formed in the lampshade connection portion, and the driving unit is arranged in the tapered or cylindrical space. Accordingly, the convenience of connection between the driving unit and the light-emitting element can be improved.

Further, the flat bulb further comprises a connection housing, and the connection housing is connected between the lampshade and the base. Accordingly, the convenience of connection between the lampshade and the base can be improved.

Further, the connection housing is fixed to the top of the base and partially accommodated in the base, and the driving unit is arranged in the connection housing. Accordingly, the connection between the connection housing and the base can be facilitated and the aesthetic appearance of the flat bulb is also taken into account.

Further, the lampshade connection portion is rotatably connected to the top of the connection housing relative to the connection housing. Accordingly, the user can manually adjust the rotation angle of the lampshade of the flat bulb relative to the base, thereby satisfying different usage requirements.

Further, the lampshade connection portion comprises an inner annular hook formed at the bottom thereof, and the connection housing comprises an outer annular hook formed at the top thereof, wherein in a state in which the lampshade is connected to the connection housing, the inner annular hook is located on the inner side of the outer annular hook in the radial direction and is snap-fitted with the outer annular hook. Accordingly, the convenience of connection between the lampshade and the connection housing can be improved.

Further, the lampshade connection portion further comprises a limiting protrusion extending from the bottom of the lampshade connection portion towards the top of the connection housing, and the connection housing further comprises a limiting boss extending from the top of the connection housing, wherein in a state in which the lampshade is connected to the connection housing, the limiting protrusion abuts against the top of the connection housing and the limiting boss abuts against the bottom of the lampshade connection portion. Accordingly, the in-position connection between the lampshade and the connection housing can be conveniently ensured.

Further, the connection housing further comprises at least one damping adjustment boss formed at the top thereof, the at least one damping adjustment boss is arranged on the inner side of the outer annular hook in the radial direction, and in a state in which the lampshade is connected to the connection housing, the inner annular hook is clamped between the outer annular hook and the at least one damping adjustment boss. Accordingly, the operational feeling of the user when rotating the lampshade can be improved, and it is convenient for the user to rotate the lampshade to a desired angle more accurately.

In addition, the present utility model further provides a flat bulb, comprising: a lampshade, the lampshade comprising a lampshade body portion and a lampshade connection portion formed at the bottom of the lampshade body portion; a light-emitting element; a driving unit, the driving unit being electrically connected to the light-emitting element; and a base, the base being connected to the lampshade connection portion by means of a connection housing for electrically connecting the flat bulb to a socket, the light-emitting element being arranged in an inner space of the lampshade, the connection housing and/or the base, and at least a part of the lampshade body portion having a flat shape. Accordingly, the flat bulb of the present utility model is of a unique design for decorative purposes and can be adapted to various different shapes, and the flat bulb can be fitted to various sockets by the user as required.

Further, the lampshade connection portion is rotatably connected to the top of the connection housing relative to the connection housing. Accordingly, the user can manually adjust the rotation angle of the lampshade of the flat bulb relative to the base, thereby satisfying different usage requirements.

### BRIEF DESCRIPTION OF THE DRAWINGS

The drawings are used for providing further understanding of the present utility model, and constitute a part of the present utility model. The schematic embodiments of the present utility model and the illustrations thereof are used for explaining the present utility model, and do not constitute improper limitations to the present utility model. In the drawings:

FIG. 1 is a schematic side view of a flat bulb according to a first embodiment of the present utility model;

FIG. 2 is a schematic exploded view of a flat bulb shown in FIG. 1;

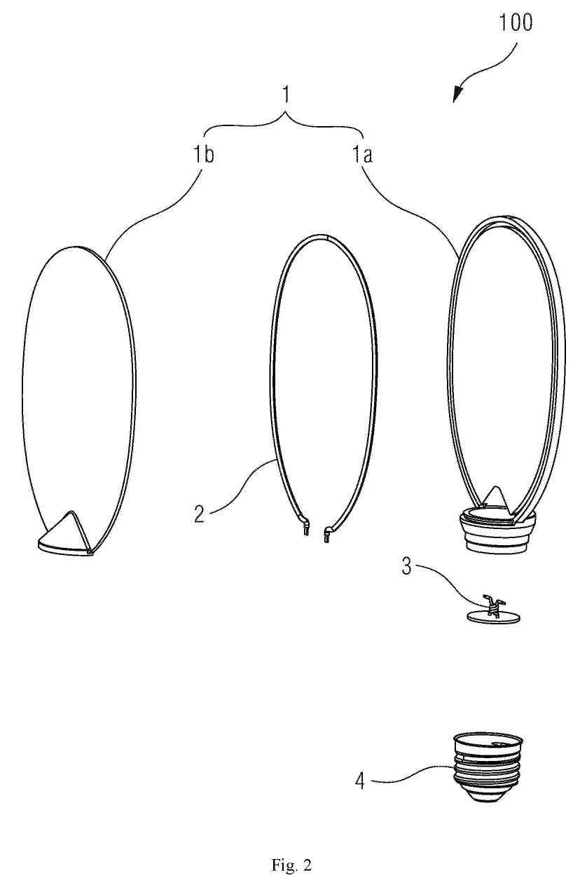

FIG. 3 is a sectional perspective view of a part of a flat bulb shown in FIG. 1;

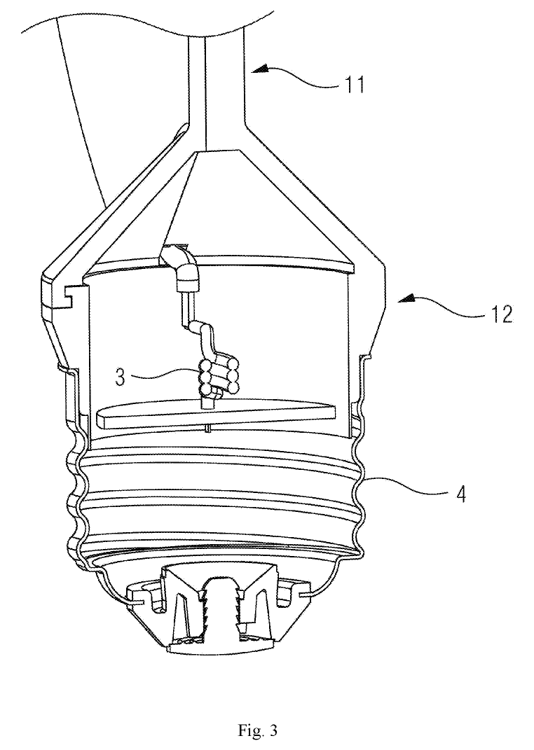

FIG. 4 is a schematic perspective view of a flat bulb according to a second embodiment of the present utility model;

FIG. 5 is a schematic exploded view of a flat bulb shown in FIG. 4;

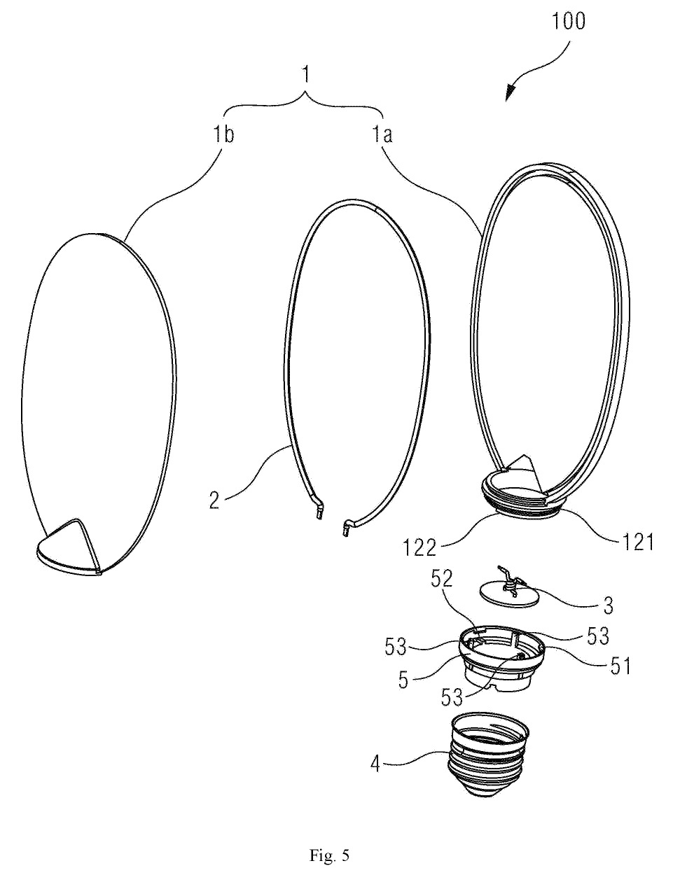

FIG. 6 is a sectional perspective view of a part of a flat bulb shown in FIG. 4; and

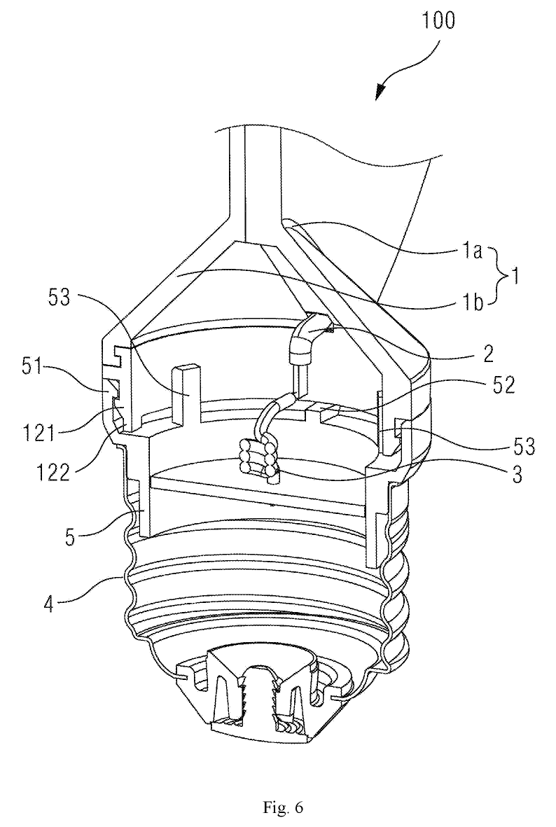

FIG. 7 is a schematic perspective view of a flat bulb of the present utility model, in which the flat bulb is installed on a socket.

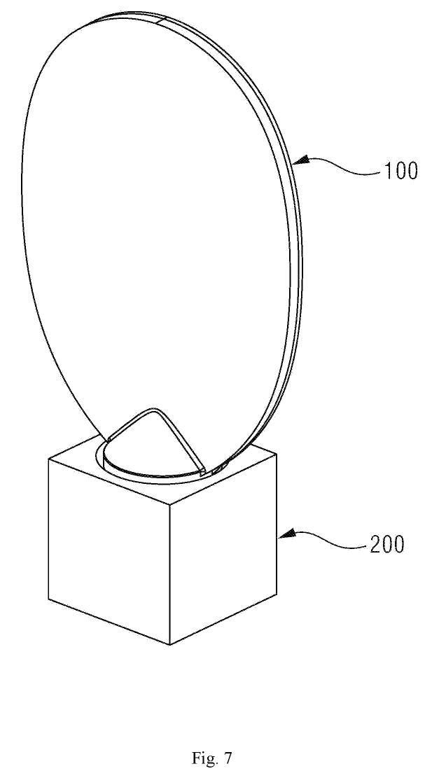

### DETAILED DESCRIPTION OF THE EMBODIMENTS

The following describes the technical solutions in the embodiments of the present utility model in detail with reference to the drawings in the embodiments of the present utility model. It should be noted that the embodiments of the present utility model and the features in the embodiments can be combined with each other without conflicts.

In the following detailed description, reference is made to the drawings which form a part of the specification, and the specific embodiments in which the present utility model can be practiced are shown by way of example illustration. Directional terms, such as "top", "bottom", "inner", "outer", "upper", "lower", "front" and "rear", with respect to the drawings, are used with reference to the direction of the drawings being described. As components of the embodiments of the present utility model may be placed in many different directions, the directional terms are used for purposes of illustration only and are not intended to be limiting. It is to be understood that other embodiments may be utilized and structural or logical changes may be made without departing from the scope of the present utility model. Therefore, the following detailed description should not be understood as limiting, and the present utility model is defined by the appended claims.

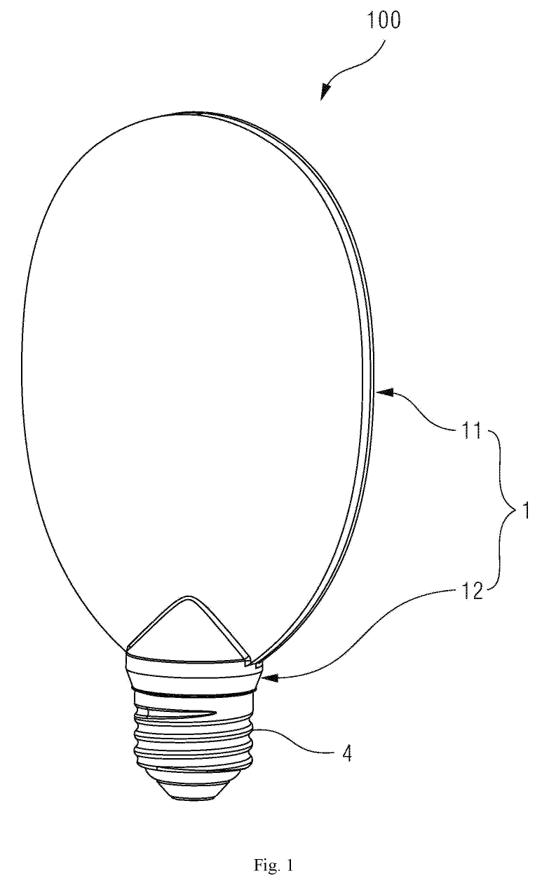

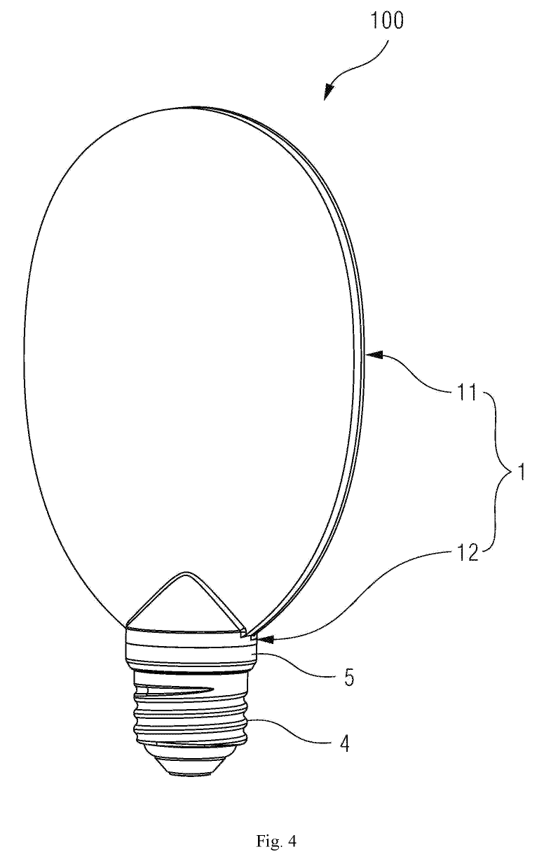

The present utility model provides a flat bulb 100. FIGS. 1 - 3 show a flat bulb according to a first embodiment of the present utility model, and FIGS. 4 - 6 show a flat bulb according to a second embodiment of the present utility model. The flat bulbs in the two embodiments have substantially the same structure except that the flat bulb in the second embodiment as shown in FIGS. 4 - 6 is additionally provided with a connection housing to connect the lampshade and the base.

As shown in FIGS. 1- 3 and 7, a flat bulb 100 may generally comprise a lampshade 1, a light-emitting element 2, a driving unit 3 and a base 4.

The lampshade 1 may comprise a lampshade body portion 11 and a lampshade connection portion 12 located at the bottom of the lampshade body portion 11. In particular, the lampshade body portion 11 and the lampshade connection portion 12 may be integrally formed, or may be separately manufactured and connected together, for example, by glue or ultrasonic welding. The driving unit 3 may be electrically connected to the light-emitting element 2. The base 4 may be connected to the lampshade connection portion 12 for electrically connecting the flat bulb 100 to a socket 200. The light-emitting element 2 may be arranged in an inner space of the lampshade 1 and/or the base 4, in other words, the light-emitting element 2 may be arranged only in the inner space of the lampshade 1, or may be arranged in the inner spaces of both the lampshade 1 and the base 4, or even arranged only in the inner space of the base 4. In particular, these inner spaces of the flat bulb, i.e. the inner space of the lampshade 1 and the inner space of the base 4, can communicate with one another to form an integral inner space, and the light-emitting element 2 can actually be arranged at any position in this inner space.

At least a part of the lampshade body portion 11 has a flat shape. In particular, most or even all parts of the lampshade body portion 11 have a flat shape, wherein the higher the proportion of the flat parts in the lampshade body portion, the better the flat appearance of the flat bulb.

In particular, the at least a part of the lampshade body portion 11 may be circular, elliptical or polygonal.

In particular, the lampshade 1 may be transparent or translucent. In other words, the lampshade 1 may be made of any suitable transparent or translucent material.

In particular, the lampshade 1 may be a filament or other light-emitting structure.

In particular, the lampshade 1 may comprise a first lampshade portion 1a and a second lampshade portion 1b, and the first lampshade portion 1a and the second lampshade portion 1b may be connected together by glue or ultrasonic welding.

Further, a groove may be formed in the first lampshade portion 1a and/or the second lampshade portion 1b, and the light-emitting element 2 is arranged in the groove. In other words, the first lampshade portion 1a and the second lampshade portion 1b may each be provided with a groove to accommodate a part of the light-emitting element 2, respectively, or only one of the first lampshade portion 1a and the second lampshade portion 1b is formed with a groove to accommodate the light-emitting element 2 individually.

In addition, the light-emitting element 2 may be arranged between the first lampshade portion 1a and the second lampshade portion 1b.

In addition, the light-emitting element 2 may be arranged around the lampshade body portion 11, in particular, at an edge of the lampshade body portion 11.

In addition, the light-emitting element 2 may be arranged in the lampshade body portion 11, but not in the lampshade connection portion 12.

In addition, the lampshade body portion 11 may be composed of a part of the first lampshade portion 1a and at least a part of the second lampshade portion 1b, and the lampshade connection portion 12 may be composed of the rest of the first lampshade portion 1a or composed of the rest of the first lampshade portion 1a and the rest of the second lampshade portion 1b. In other words, the lampshade connection portion 12 may be composed of only a part of the first lampshade portion 1a, or may be composed of both a part of the first lampshade portion 1a and a part of the second lampshade portion 1b.

In particular, the driving unit 3 may be arranged in the base 4. Further, a tapered or cylindrical space may be formed in the base 4, and the driving unit 3 is arranged in the tapered or cylindrical space.

Of course, the position arrangement of the driving unit 3 is not limited thereto. For example, the driving unit 3 may be arranged at an interface between the base 4 and the lampshade connection portion 12. Alternatively, the driving unit 3 may be arranged in the lampshade connection portion 12. Further, a tapered or cylindrical space may be formed in the lampshade connection portion 12, and the driving unit 3 is arranged in the tapered or cylindrical space.

In addition, as shown in FIGS. 4 - 6, the flat bulb 100 may further comprise a connection housing 5, and the connection housing 5 is connected between the lampshade 1 and the base 4.

In particular, the connection housing 5 may be fixed to the top of the base 4 and partially accommodated in the base 4, and the driving unit 3 may be arranged in the connection housing 5.

In particular, the lampshade connection portion 12 is rotatably connected to the top of the connection housing 5 relative to the connection housing 5.

Further, the lampshade connection portion 12 may comprise an inner annular hook 121 formed at the bottom thereof, and the connection housing 5 may comprise an outer annular hook 51 formed at the top thereof. In a state in which the lampshade 1 is connected to the connection housing 5, the inner annular hook 121 is located on the inner side of the outer annular hook 51 in the radial direction and is snap-fitted with the outer annular hook 51. Of course, the connection manner between the lampshade connection portion 12 and the connection housing 5 is not limited thereto, and they may be connected to each other in any manner as long as rotation can be achieved. Further, the radial positions of the inner annular hook 121 and the outer annular hook 51 can be reversed, in other words, the lampshade connection portion 12 may comprise an outer annular hook and the connection housing 5 may comprise an inner annular hook.

Further, the lampshade connection portion 12 may further comprise a limiting protrusion 122 extending from the bottom of the lampshade connection portion towards the top of the connection housing 5, and the connection housing 5 may further comprise a limiting boss 52 extending from the top of the connection housing 5. In a state in which the lampshade 1 is connected to the connection housing 5, the limiting protrusion 122 abuts against the top of the connection housing 5 and the limiting boss 52 abuts against the bottom of the lampshade connection portion 12.

Further, the connection housing 5 may further comprise at least one damping adjustment boss 53 formed at the top thereof, and the at least one damping adjustment boss 53 is arranged on the inner side of the outer annular hook 51 in the radial direction. In a state in which the lampshade 1 is connected to the connection housing 5, the inner annular hook 121 is clamped between the outer annular hook 51 and the at least one damping adjustment boss 53.

In addition, the present utility model further provides a flat bulb. The flat bulb comprises: a lampshade 1, the lampshade 1 comprising a lampshade body portion 11 and a lampshade connection portion 12 formed at the bottom of the lampshade body portion 11; a light-emitting element 2; a driving unit 3, the driving unit 3 being electrically connected to the light-emitting element 2; and a base 4, the base 4 being connected to the lampshade connection portion 12 by means of a connection housing 5 for electrically connecting the flat bulb 100 to a socket 200, the light-emitting element 2 being arranged in an inner space of the lampshade 1, the connection housing 5 and/or the base 4, wherein at least a part of the lampshade body portion 11 has a flat shape. In particular, these inner spaces of the flat bulb, i.e. the inner space of the lampshade 1, the inner space of the connection housing 5 and the inner space of the base 4, can communicate with one another to form an integral inner space, and the light-emitting element 2 can actually be arranged at any position in this inner space.

The above are only the preferred embodiments of the present utility model, and are not intended to limit the present utility model. For those skilled in the art, the present utility model may have various modifications and variations. Any modifications, equivalent replacements, improvements and the like made within the spirit and principle of the present utility model shall fall within the scope of protection of the present utility model.

1. A flat bulb, comprising:
a lampshade, the lampshade comprising a lampshade body portion and a lampshade connection portion located at the bottom of the lampshade body portion;
a light-emitting element;
a driving unit, the driving unit being electrically connected to the light-emitting element; and
a base, the base being connected to the lampshade connection portion for electrically connecting the flat bulb to a socket, and the light-emitting element being arranged in an inner space of the lampshade and/or the base,
wherein at least a part of the lampshade body portion has a flat shape.

2. The flat bulb according to claim 1, wherein
the at least a part of the lampshade body portion is circular, elliptical or polygonal; and/or
the lampshade is transparent or translucent; and/or
the light-emitting element is a filament.

3. The flat bulb according to claim 1, wherein the lampshade comprises a first lampshade portion and a second lampshade portion, and the first lampshade portion and the second lampshade portion are connected together by glue or ultrasonic welding.

4. The flat bulb according to claim 3, wherein a groove is formed in the first lampshade portion and/or the second lampshade portion, and the light-emitting element is arranged in the groove.

5. The flat bulb according to claim 3, wherein the light-emitting element is arranged between the first lampshade portion and the second lampshade portion.

6. The flat bulb according to claim 3, wherein the light-emitting element is arranged around the lampshade body portion.

7. The flat bulb according to claim 3, wherein the light-emitting element is arranged in the lampshade body portion.

8. The flat bulb according to claim 3, wherein the lampshade body portion is composed of a part of the first lampshade portion and at least a part of the second lampshade portion, and the lampshade connection portion is composed of the rest of the first lampshade portion or composed of the rest of the first lampshade portion and the rest of the second lampshade portion.

9. The flat bulb according to claim 1, wherein the driving unit is arranged in the base.

10. The flat bulb according to claim 9, wherein a tapered or cylindrical space is formed in the base, and the driving unit is arranged in the tapered or cylindrical space.

11. The flat bulb according to claim 1, wherein the driving unit is arranged at an interface between the base and the lampshade connection portion.

12. The flat bulb according to claim 1, wherein the driving unit is arranged in the lampshade connection portion.

13. The flat bulb according to claim 12, wherein a tapered or cylindrical space is formed in the lampshade connection portion, and the driving unit is arranged in the tapered or cylindrical space.

14. The flat bulb according to claim 1, wherein the flat bulb further comprises a connection housing, and the connection housing is connected between the lampshade and the base.

15. The flat bulb according to claim 14, wherein the connection housing is fixed to the top of the base and partially accommodated in the base, and the driving unit is arranged in the connection housing.

16. The flat bulb according to claim 14, wherein the lampshade connection portion is rotatably connected to the top of the connection housing relative to the connection housing.

17. The flat bulb according to claim 16, wherein the lampshade connection portion comprises an inner annular hook formed at the bottom thereof, and the connection housing comprises an outer annular hook formed at the top thereof, wherein in a state in which the lampshade is connected to the connection housing, the inner annular hook is located on the inner side of the outer annular hook in the radial direction and is snap-fitted with the outer annular hook.

18. The flat bulb according to claim 17, wherein the lampshade connection portion further comprises a limiting protrusion extending from the bottom of the lampshade connection portion towards the top of the connection housing, and the connection housing further comprises a limiting boss extending from the top of the connection housing, wherein in a state in which the lampshade is connected to the connection housing, the limiting protrusion abuts against the top of the connection housing and the limiting boss abuts against the bottom of the lampshade connection portion.

19. The flat bulb according to claim 17, wherein the connection housing further comprises at least one damping adjustment boss formed at the top thereof, the at least one damping adjustment boss is arranged on the inner side of the outer annular hook in the radial direction, and in a state in which the lampshade is connected to the connection housing, the inner annular hook is clamped between the outer annular hook and the at least one damping adjustment boss.

20. A flat bulb, comprising:
a lampshade, the lampshade comprising a lampshade body portion and a lampshade connection portion formed at the bottom of the lampshade body portion;
a light-emitting element;
a driving unit, the driving unit being electrically connected to the light-emitting element; and
a base, the base being connected to the lampshade connection portion by means of a connection housing for electrically connecting the flat bulb to a socket, and the light-emitting element being arranged in an inner space of the lampshade, the connection housing and/or the base,
wherein at least a part of the lampshade body portion has a flat shape.

21. The flat bulb according to claim 20, wherein the lampshade connection portion is rotatably connected to the top of the connection housing relative to the connection housing.

22. A flat bulb, comprising:
a lampshade comprising a transparent lampshade body portion and a lampshade connection portion formed at the bottom of the lampshade body portion;
a light-emitting element formed in flexible filament;
a driving unit being electrically connected to the light-emitting element; and
a base being connected to the lampshade connection portion by means of a connection housing for electrically connecting the flat bulb to a socket, and the light-emitting element being arranged in peripherals of the lampshade,
wherein at least a part of the lampshade body portion has a flat shape.
